(19) United States
(12) Patent Application Publication
(10) Pub. No.: US 2019/0343088 A1
(43) Pub. Date: Nov. 14, 2019

(54) CHICKEN RETRIEVAL BASKET FOR SEPARATING SICK, LAME OR INJURED FOWL AND CHICKENS FROM A FLOCK

(71) Applicant: Warren M. Martin, Leola, PA (US)

(72) Inventor: Warren M. Martin, Leola, PA (US)

(21) Appl. No.: 15/978,572

(22) Filed: May 14, 2018

(51) Int. Cl. A01K 45/00

(52) U.S. Cl. CPC A01K 45/005

(57) ABSTRACT

A chicken retrieval basket for retrieving chickens to be culled from a flock. The chicken retrieval basket includes a main frame having a wire mesh panel secured to the top of the main frame such that the wire mesh panel extends downwardly and underneath the basket so as to form the side wall and bottom of the basket.

### FIELD OF THE INVENTION

The present invention relates to devices configured to catch and separate chickens from a flock.

### BACKGROUND OF THE INVENTION

Culling is a necessary process in raising and growing fowl and chickens. Culling enables the grower to remove sick, lame or injured chickens, as well as runts, from the flock which, in the end, increases efficiency and productivity. One of the challenges in culling and euthanizing sick, lame or injured chickens, for the poultry industry and growers, is being able to cull and euthanize in an appropriate or humane way. One of the problems in culling and euthanization is that in some cases identifying the runt, sick, lame or injured chicken to be euthanized and actually euthanizing the chicken take place at the same time among the flock. This sometimes results in an inappropriate euthanization. This process can be improved by separating the sick, lame or injured chicken from the flock and after separation, performing the euthanization in an environment outside the flock where euthanization can be appropriately performed in the most humane way.

Therefore, there has been and continues to be a need for an efficient and appropriate way of culling the chickens by separating sick, lame or injured chickens from the flock, after which appropriate euthanization can be performed.

### SUMMARY OF THE INVENTION

The present invention relates to a basket, referred to as a chicken retrieval basket, that can be used to separate sick, lame or injured chickens from the flock. The basket is designed such that it can be used in the midst of the flock and can retrieve targeted chickens without frightening the chickens and making retrieval even more difficult and time consuming.

In one embodiment, the chicken retrieval basket comprises an open metal frame that includes a top circular ring, a bottom circular ring, and a plurality of vertical ties interconnected between the top and bottom circular rings. A wire mesh panel extends across the bottom and sides of the metal frame. This wire mesh panel includes an array of galvanized steel wires twisted together to form an array of openings across the mesh panel. In this particular embodiment, the mesh panel extends over the exterior side of the bottom circular ring and upwardly therefrom to where the wire mesh panel extends between the circular rings. Thus, the wire mesh panel forms a bottom of the chicken retrieval basket, as well as the side wall of the basket. To secure the wire mesh panel to the metal frame, an outer edge of the wire mesh panel is secured to the top circular ring. This effectively secures or suspends the wire mesh panel around the open metal frame and encloses the open metal frame except for the top.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of the chicken retrieval basket.

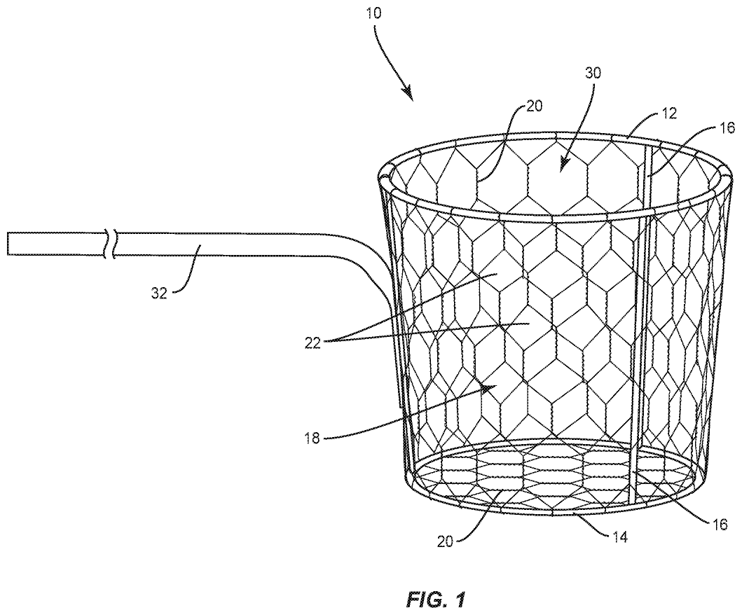

FIG. 2 is a side elevational view of the chicken retrieval basket.

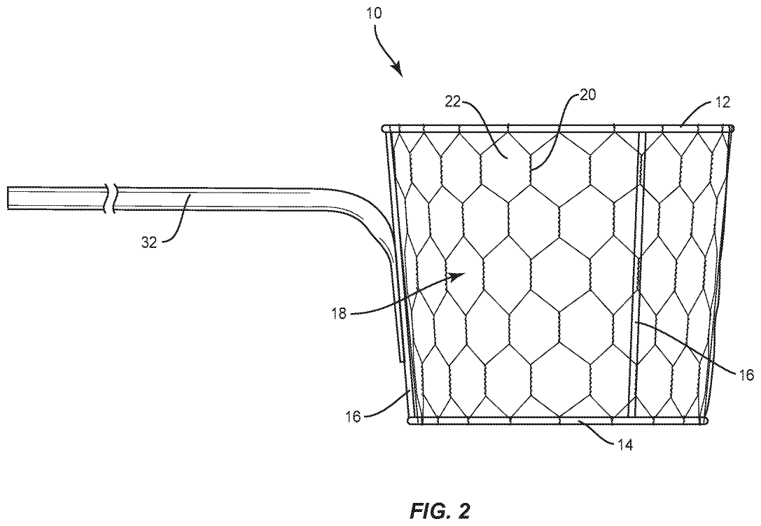

FIG. 3 is a top plan view of the chicken retrieval basket.

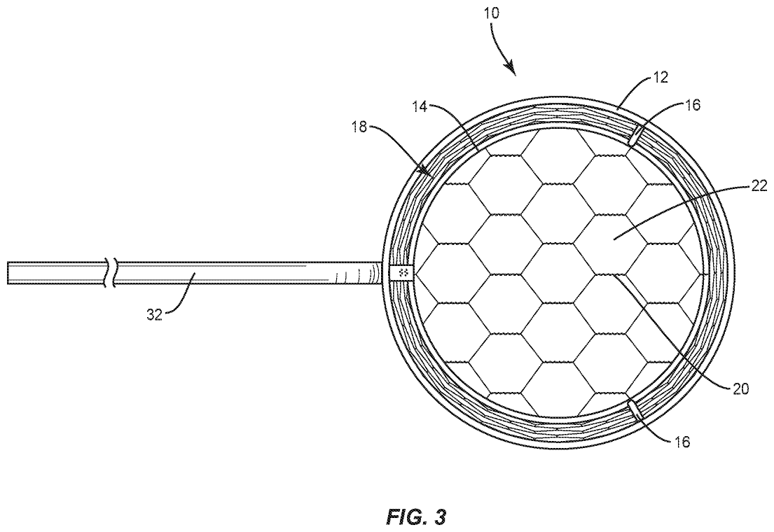

FIG. 4 is one end elevational view of the chicken retrieval basket.

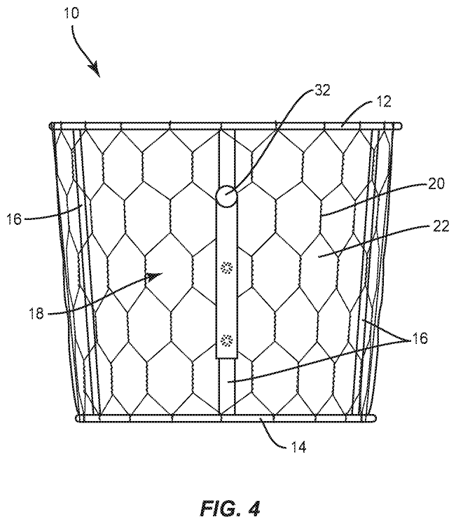

FIG. 5 is an end elevational view of the end of the chicken retrieval basket opposite that shown in FIG. 4.

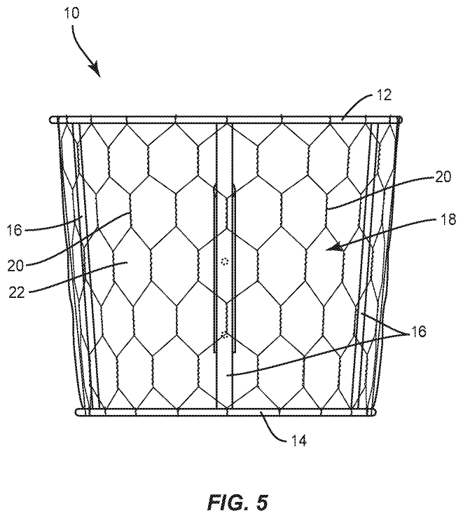

FIG. 6 is another perspective view of the chicken retrieval basket showing a chicken in the basket.

FIG. 7 is a view of the wire mesh panel shown underlying the main frame of the chicken retrieval basket.

### DESCRIPTION OF EXEMPLARY EMBODIMENTS

With further reference to the drawings, a chicken retrieval basket is shown therein and indicated generally by the numeral 10. As explained below, the chicken retrieval basket is utilized to catch and retrieve sick, lame or injured chickens among a flock. By retrieving such targeted chickens, the grower can then carry the chicken to a euthanizing area. This separates the catching and retrieving of the chicken from the euthanization process and by separating the two, more appropriate ways can be employed for both catching and retrieving and euthanization.

The chicken retrieval basket comprises a main frame. The main frame forms the frame of the basket and can be constructed of various suitable materials. In preferred embodiments, the main frame is a metal (such as aluminum) or plastic frame. As seen in the drawings, it is of an open construction and is designed such that its components are relatively small or thin. Viewing the metal of plastic frame in more detail, it comprises a top circular ring 12, a bottom circular ring 14 and an array of vertical ties 16 that extends between the top circular ring and the bottom circular ring. The vertical ties are actually interconnected between the two rings 12 and 14 and are uniformly spaced around the side of the chicken retrieval basket 10. Circular rings 12 and 14, along with the vertical ties 16, form a generally rigid structure.

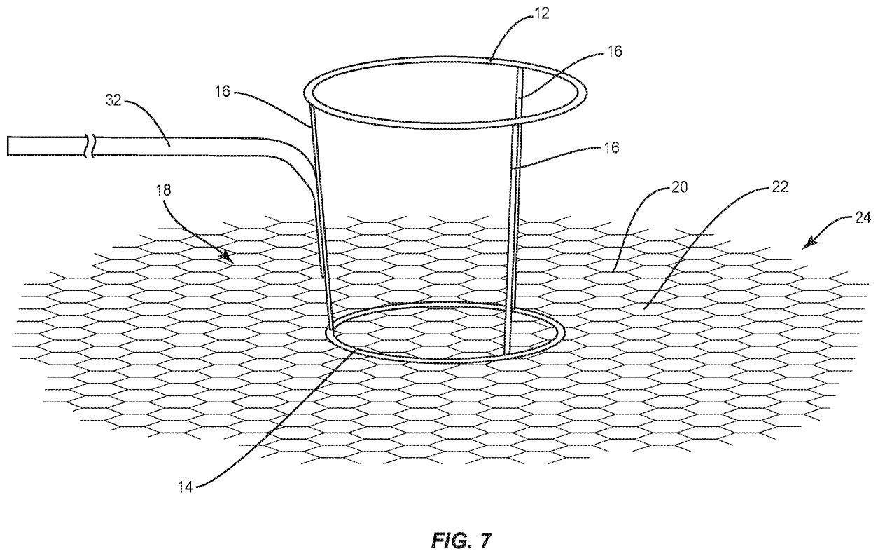

The side wall and bottom of the chicken retrieval basket 10 are formed by a wire mesh panel indicated generally by the numeral 18. See FIG. 7. The wire mesh panel can be constructed of various suitable materials. In one embodiment, the wire mesh panel 18 is constructed of galvanized steel wires 20 that are twisted together to form an array of openings 22 that are present across the entire wire mesh panel. Openings 22 are of various shapes with some typically assuming a hexagonal shape. FIG. 7 shows the wire mesh panel 18 laid out in a single plane. Wire mesh panel 18 includes an outer edge 24. To form the bottom and side wall of the chicken retrieval basket 10, the wire mesh panel 18 is suspended to the metal or plastic frame structure. That is, the wire mesh panel 18 is used to form the bottom and side wall of the chicken retrieval basket. This is achieved by positioning the wire mesh panel 18 underneath the bottom circular ring 14 and with portions of the wire mesh panel pulled upwardly towards the top circular ring 12. As seen in FIG. 7, the main frame is placed over the wire mesh panel 18. To secure the wire mesh panel 18 to the main frame, the outer portions of the wire mesh panel are pulled upwardly around the main frame and the outer edge 24 of the wire mesh panel is secured to the top circular ring 12. It is noted that the wire mesh panel 18 extends exteriorly of the bottom circular ring 14 and the plurality of vertical ties 16. Expressed in another way, when the wire mesh panel 18 is secured to the metal or plastic frame, the bottom circular ring 14 and the vertical ties 16 lie inside of the wire mesh panel.

The outer edge 24 of the wire mesh panel 18 is connected to the top circular ring 12. This connection can be made in various ways. In one example, the outer edge portion 24 of the wire mesh panel 18 includes a plurality of wires that are wrapped around and tied to the top circular panel 12. This effectively suspends the wire mesh panel 18 from the top circular ring 12. The suspension of the wire mesh panel 18 is done such that the wire mesh panel generally conforms to the shape of the metal or plastic frame. While there may be some flexibility in portions of the wire mesh panel that extend around the main frame, the various portions of the wire mesh panel still contribute to forming a basket-like structure.

Once the wire mesh panel 18 is suspended from the top circular ring 12, a portion of the wire mesh panel forms a wire mesh bottom that is maintained relatively taunt but with some slight flexibility that encourages a retrieved chicken to sit and rest in the bottom of the chicken retrieval basket. Another portion of the wire mesh panel 18 forms a wire mesh side wall that extends around the side of the chicken retrieval basket.

Thus, as appreciated from viewing the drawings, once the wire mesh panel has been suspended to the top circular ring 12, this leaves an open top 30 that enables the targeted chicken to pass through during a retrieval operation.

In order to manipulate and carry the chicken retrieval basket 10, there is provided an elongated handle 32. Handle 32 is connected to the main frame of the chicken retrieval basket 10 and extends therefrom. As shown in the drawings, in one embodiment, the handle includes a curved end portion that is secured by fasteners, weldment, or other suitable means to one of the vertical ties 16. Handle 32 can be designed such that its length is adjustable. In one embodiment, handle 32 may comprise a plurality of telescoping sections that enable the length of the handle to be adjusted.

It is appreciated by those skilled in the art that the size and dimensions of the chicken retrieval basket 10 can vary. In one example, the top circular ring 12 has a diameter of 12 inches while the bottom circular ring 14 has a diameter of 10½ inches. The height of this exemplary basket is approximately 10 inches. In this example, it is noted that the wire mesh side wall, as well as the main frame, taper inwardly from the top ring 12 to the bottom ring 14. This facilitates catching the targeted chicken and confining the chicken in the basket after being captured.

It is beneficial for the entire basket 10, including the main frame and the wire mesh panel 18, to be of a light weight construction. This makes the basket 10 easy to handle and manipulate around a targeted chicken. At the same time, by employing relatively small and lightweight materials, the basket as a whole is made generally transparent, that is the side wall and the bottom are not opaque but are of an open wire mesh construction that enables light to be transmitted through the entire basket. Thus, in one example, the galvanized steel wire that comprises the wire mesh panel 18 can be constructed of 19-22 gauge steel wire.

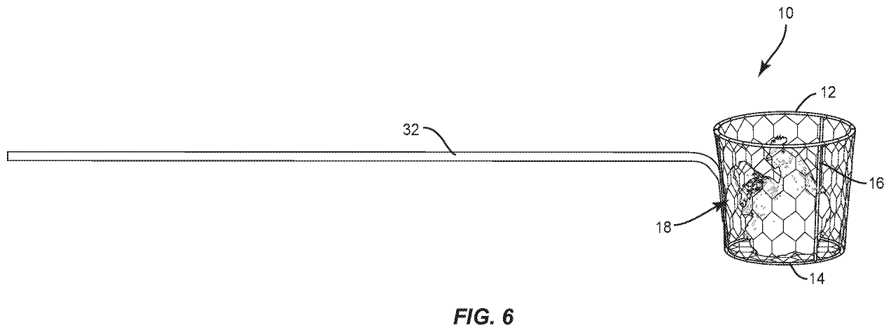

The chicken retrieval basket 10 is used by a worker walking through a chicken house among the flock and identifying sick, lame or injured chickens. Once the worker identifies such a chicken, then he or she moves to capture the chicken in the chicken retrieval basket 10. A number of different basket designs have been tested and it was found that a design that was generally open and transmitted light worked better than other designs because the basket could be directed at the targeted chicken without unduly scaring the chicken and causing the chicken to run away from the basket. In any event, once the targeted chicken is retrieved in the basket (see FIG. 6), then the worker can transfer the targeted chicken to a euthanizing area where the chicken can be euthanized in a humane and appropriate way. As used herein, the term “chicken” means a chicken or any type of fowl, such as a turkey.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A chicken retrieval basket configured to retrieve sick, lame or injured chickens and which is used in a process for culling chickens from a flock, the chicken retrieval basket comprising:
a rigid metal frame including a top circular ring, a bottom circular ring and a series of spaced apart vertical ties that extend between the top and bottom circular rings and which interconnect the top and bottom circular rings;
wherein the top circular ring includes a diameter greater than the diameter of the bottom circular ring;
a mesh wire panel comprising an array of galvanized steel wires twisted together to form a plurality of openings throughout the wire panel;
the mesh wire panel having an outer edge;
the mesh wire panel extending across an exterior side of the bottom circular ring to form a wire mesh bottom of the chicken retrieval basket;
wherein the wire mesh panel extends upwardly from the wire mesh bottom where portions of the wire mesh panel extend between the top and bottom circular rings and form a circular wire mesh side of the chicken retrieval basket;
wherein the outer edge of the wire mesh panel is secured to the top circular ring, thereby suspending the wire mesh panel to the metal frame;
wherein the metal frame, wire mesh bottom and circular wire mesh side form an open top chicken retrieval basket; and
an elongated handle secured to the wire metal frame and extending therefrom.

2. The chicken retrieval basket of claim 1 wherein the wire mesh bottom and circular wire mesh side are formed from a single piece of the wire mesh panel and wherein the single piece of the wire mesh panel is directly attached to the top circular ring.

3. The chicken retrieval basket of claim 2 wherein the metal frame sits within the confines of the single piece of wire mesh panel.

4. A chicken retrieval basket configured to retrieve sick, lame or injured chickens which is used in a process for culling chickens from a flock, the chicken retrieval basket comprising:
a metal or plastic frame including a top circular ring, a bottom circular ring and a plurality of spaced apart vertical ties extending between the top and bottom circular rings and which interconnect the top and bottom circular rings;
a first wire mesh section extending across the bottom circular ring and which forms a wire mesh bottom of the chicken retrieval basket, the wire mesh bottom comprising a plurality of steel wires twisted together which form a plurality of openings across the wire mesh bottom;
a second wire mesh section extending between the top and bottom circular rings and which form a wire mesh side wall of the chicken retrieval basket, the wire mesh side wall comprising a plurality of steel wires twisted together which form a plurality of openings across the wire mesh side wall;
wherein the top circular ring forms an opening that is configured to permit chickens to pass therethrough and into the chicken retrieval basket; and
an elongated handle secured to the metal or plastic frame and extending therefrom.

5. The chicken retrieval basket of claim 4 wherein the wire mesh bottom and the wire mesh side wall form a single wire mesh panel having an outer edge secured to the top circular ring such that the single wire mesh panel is suspended from the top circular ring and extends around the chicken retrieval basket exteriorly of the bottom circular ring and the vertical ties.

6. The chicken retrieval basket of claim 5 wherein the top circular ring includes a diameter that is greater than the diameter of the bottom circular ring and wherein the wire mesh side wall tends to taper downwardly and inwardly from the top circular ring.
